(19) United States
(12) Patent Application Publication
(10) Pub. No.: US 2008/0191051 A1
(43) Pub. Date: Aug. 14, 2008

(54) Nozzle Assembly

(75) Inventors: Manfred Faubel, Rosdorf (DE); Detlef Wolf, Uslar (DE); Jurgen Troe, Gottingen (DE); Ales Charvat, Gottingen (DE); Eugene Lugovi, Gottingen (DE); Jens Assmann, Mannheim (DE); Bernd Abel, Dransfeld (DE)

Correspondence Address: THE LAW OFFICE OF RANDALL T. ERICKSON, P.C., 1749 S. NAPERVILLE ROAD, SUITE 202, WHEATON, IL, 60187, US

(73) Assignees: Max-Planck-Gesellschaft zur Forderung der Wissenschaften e.V.; Georg-August-Universitat Gottingen

(21) Appl. No.: 10/546,899

(22) PCT Filed: Feb. 23, 2004
(86) PCT No.: PCT/EP04/01761

§ 371 Date: Jun. 16, 2006

(30) Foreign Application Priority Data
Feb. 26, 2003 (DE) 10308299.9

(51) Int. Cl. B05B 1/02; B05B 1/04

(52) U.S. Cl. 239/8; 239/601; 239/597

(57) ABSTRACT

The invention relates to a nozzle arrangement (1), in particular for the injection of a fluid into a vacuum chamber, with a nozzle channel with a predetermined internal contour, whereby the nozzle channel leads into an exit opening. It is proposed that the internal contour of the nozzle channel be shaped concavely at least in part.

The invention relates to a nozzle arrangement, in particular for the injection of a fluid jet into a vacuum chamber, according to the preamble of claim 1.

X-radiation sources are known, wherein a fluid target material is injected with a nozzle arrangement into a vacuum chamber and transferred there by laser irradiation into a plasma state, in which material-specific x-ray fluorescence radiation is emitted. It is important here that the injected fluid jet is kept as stable as possible in the vacuum chamber, but this has been unsatisfactory hitherto with the known nozzle arrangements.

A nozzle arrangement for material processing is known for example from U.S. Pat. No. 4,131,236, whereby this nozzle arrangement has a nozzle channel, which tapers towards the exit opening and has a convex internal contour. The use of such nozzle arrangements for the injection of a fluid jet into a vacuum chamber, however, leads to an unstable fluid jet inside the vacuum chamber.

The problem underlying the invention, therefore, is to provide a nozzle arrangement which produces as stable a fluid jet as possible during the injection into a vacuum chamber.

This problem is solved, based on the known jet arrangement described above according to the preamble of claim 1, by the characterising features of claim 1.

The invention is based on the knowledge that the stability of the fluid jet injected into the vacuum chamber is promoted by a flow inside the fluid jet being as laminar as possible.

The invention thus comprises the general technical teaching that the nozzle arrangement be designed in such a way that the flow is as laminar as possible at the exit opening of the nozzle arrangement.

The nozzle arrangement according to the invention, therefore, has a nozzle channel with an internal contour shaped concavely at least in part.

The term “concave internal contour” used within the scope of the invention is to be understood in general terms and is not to be restricted to the narrower mathematical definition of this term. For example, the internal contour of the nozzle channel with the nozzle arrangement according to the invention can also be simply arched outwards.

In a preferred embodiment of the nozzle arrangement according to the invention, however, the nozzle channel has a parabolic internal contour, which has proved to be particularly advantageous.

Preferably, the concave or parabolic internal contour of the nozzle channel extends, proceeding from the exit opening, against the jet direction over a predetermined region. Within the scope of the invention, therefore, it is not necessary for the concave or parabolic internal contour of the nozzle channel to extend over the whole length of the nozzle arrangement.

In a preferred embodiment, the nozzle channel extends in a nozzle body, whereby the nozzle body has at least in part a convex external contour. The term “convex external contour” used within the scope of the invention is also to be understood in general terms and is not restricted to the narrow mathematical definition of this term. For example, the nozzle body can also merely have a spherical or outwardly arched external contour, whereby the external contour preferably tapers in the direction of the exit opening.

Preferably, however, the nozzle body has a parabolic external contour, which has proved to be particularly advantageous with the injection of a fluid jet into a vacuum chamber.

The convex or parabolic external contour of the nozzle body preferably extends, proceeding from the exit opening, against the jet direction over a predetermined region. Within the scope of the invention, therefore, it is not necessary for the convex or parabolic external contour of the nozzle body to extend over its whole length.

The nozzle body is preferably made of quartz, sapphire, glass or another dielectric. Such a material selection for the nozzle body leads advantageously to a long lifetime, since these materials as dielectrics are not subject to any electro-chemical corrosion, which is important especially in the case of the initially mentioned x-ray sources which generate many ions. A further advantage of glass as the material for the nozzle body consists in the good workability, since exit openings with an internal diameter of 1 μm to 1 mm can be produced.

With regard to the material of the nozzle body, however, the invention is not restricted to the aforementioned materials, but can also be produced for example with a nozzle body of plastics material, insofar as the plastics material used is sufficiently erosion-resistant and smooth.

In a further variant of the invention, the nozzle body is made of a see-through (transparent) material such as glass for example. The transparency of the nozzle body offers the advantage here that bubbles or contaminations in the nozzle channel can be detected by a simple visual inspection, as a result of which fault-locating is greatly simplified.

There are manifold possibilities regarding the diameter of the exit opening of the nozzle arrangement, but the internal diameter of the exit opening preferably lies in the range from 1 μm to 0.5 mm, an arbitrarily large number of intermediate values being possible. For the injection of a fluid jet into a vacuum chamber, an internal diameter of the exit opening in the range from 5 μm to 0.25 mm has proved to be particularly advantageous.

Furthermore, the nozzle body is preferably made of a thermally conductive material, in order to prevent overcooling or even freezing of the fluid in the nozzle channel. This is especially advantageous when the nozzle arrangement according to the invention is used for the injection of a fluid jet into a vacuum chamber, since fluid evaporates on account of the vacuum, which on account of the associated latent heat leads to cooling of the fluid.

In the preferred embodiment of the invention, the nozzle body is connected to a supply line, whereby a seal is disposed between the nozzle body and the supply line. The seal has on the one hand the function of sealing the transition between the supply line and the nozzle body. On the other hand, the seal is intended to prevent the relatively hard supply line from abutting directly against the nozzle body which is also relatively hard, since this would be associated with considerable wear. The seal is therefore preferably made of a much softer material than the nozzle body and/or the supply line. For example, the seal can be made of a plastics material such as nylon, but other materials are also possible.

Internal channels for supplying the injected fluid also run in the supply line and the seal. The supply line preferably has an internal channel with an internal diameter from 0.1 mm to 5 mm, whilst the internal channel disposed in the seal preferably has an internal diameter in the range from 0.01 mm to 5 mm.

In order to achieve as stable a fluid jet as possible, furthermore, it has proved to be advantageous if the internal diameters of the internal channels in the supply line, the seal and in the nozzle channel differ by less than the factor 2.

In the preferred embodiment of the invention, furthermore, a screwed connection is provided in order to connect the supply line, the seal and/or the nozzle body to one another. To advantage, such a screwed connection enables straightforward dismantling of the nozzle arrangement, for example for cleaning purposes.

This screwed connection preferably comprises a screw sleeve which can be screwed up with the supply line and a screw cap which can be screwed up with the screw sleeve. The screw cap preferably has a shoulder for a tool in order to screw down the screw cap.

Furthermore, it should be mentioned that the nozzle arrangement according to the invention preferably has a compressive strength of at least 100 bar, since preferably all the components are designed in one piece and for example do not have any weld seams.

Furthermore, the invention comprises a device with a vacuum chamber and a nozzle arrangement according to any one of the preceding claims for the injection of a fluid jet into the vacuum chamber. For example, the nozzle arrangement according to the invention is, to advantage, suitable for the injection of target material into a vacuum chamber of an x-ray source, as was described briefly at the outset, of a photoelectron spectrometer or a mass spectrometer.

In order to achieve a stable fluid jet in the vacuum chamber, it has proved advantageous if the vacuum chamber is not evacuated until the fluid jet has been started.

In addition, it may be advisable for the nozzle arrangement according to the invention to be heated thermostatically in order to compensate for the latent heat arising during the injection of the fluid into the vacuum chamber, without increasing the fluid vapour pressure excessively.

Other advantageous developments of the invention are characterised in the dependent claims and are explained in greater detail below with the aid of the figures together with the description of the preferred examples of embodiment of the invention. In the figures:

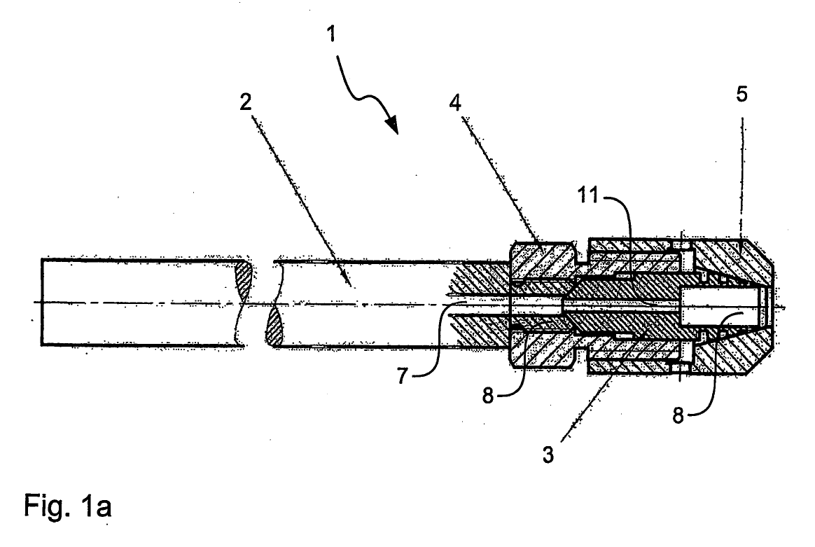

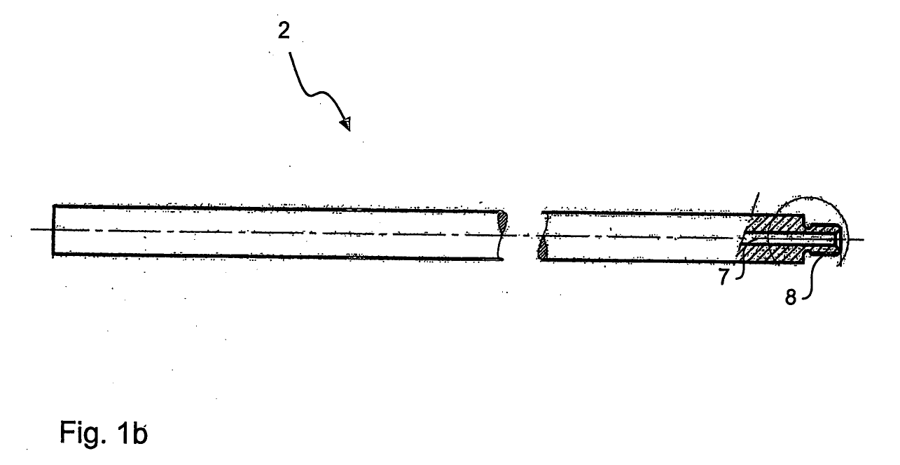

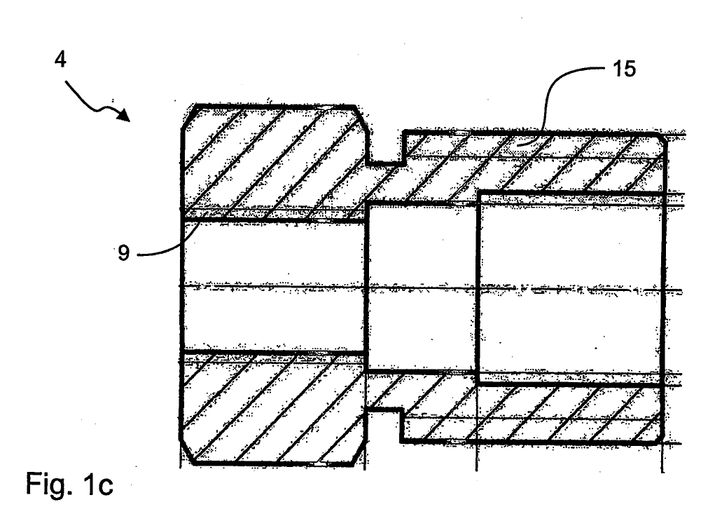

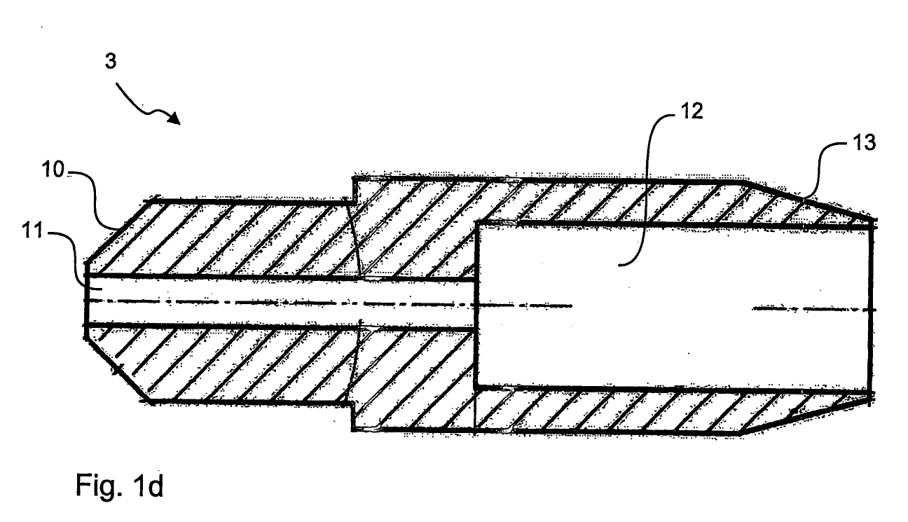

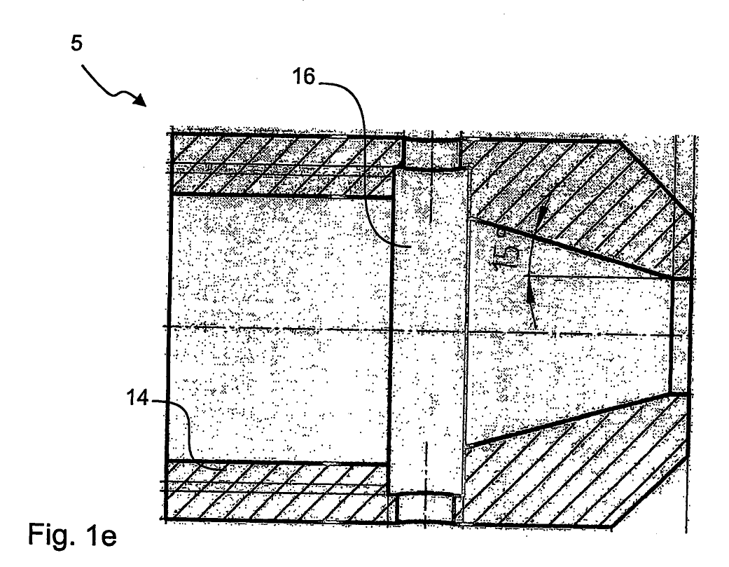

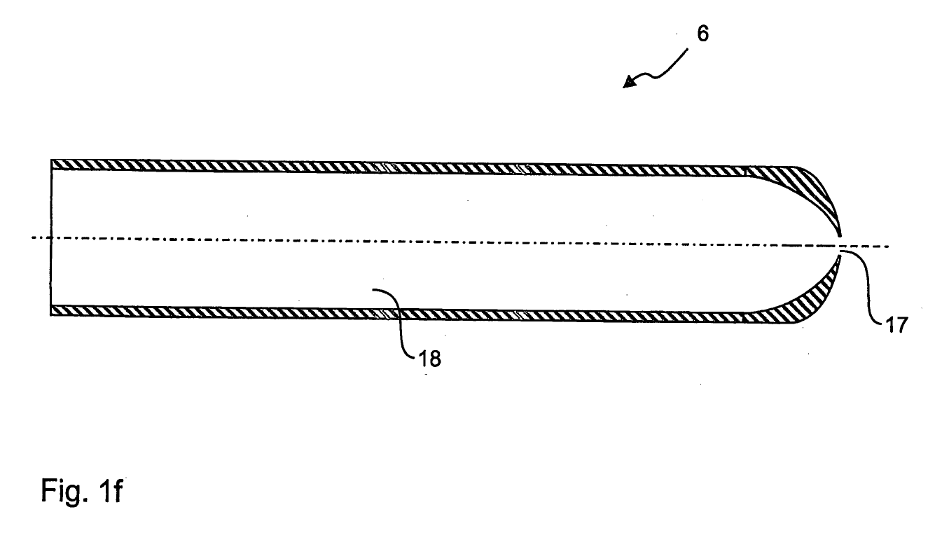

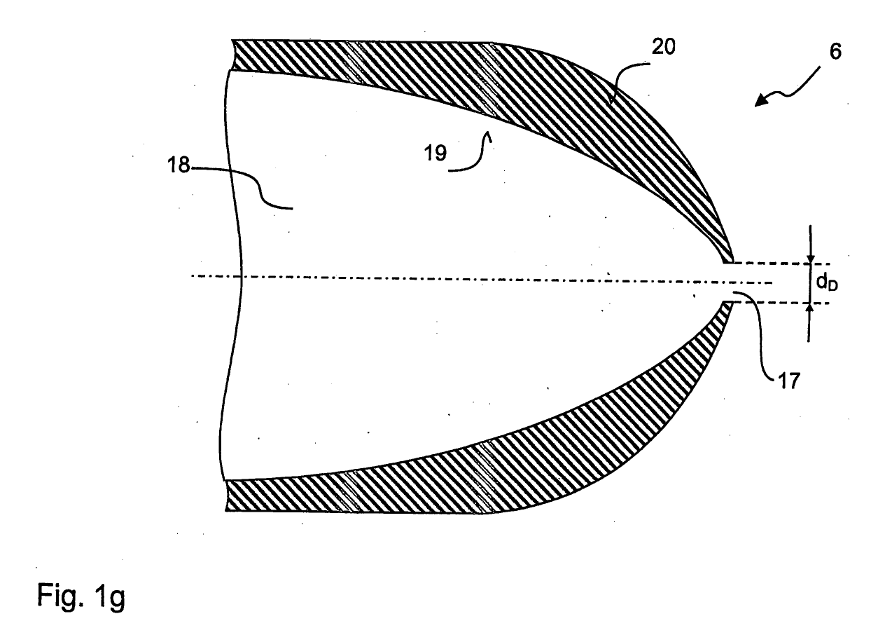

FIG. 1a shows a nozzle arrangement according to the invention in a cross-sectional view,

FIG. 1b shows the supply line of the nozzle arrangement from FIG. 1a in a cross-sectional view,

FIG. 1c shows the screw sleeve of the nozzle arrangement from FIG. 1a in a cross-sectional view,

FIG. 1d shows a cross-sectional view of the seal of the nozzle arrangement from FIG. 1a,

FIG. 1e shows a cross-sectional view of the screw cap of the nozzle arrangement from FIG. 1a,

FIG. 1f shows the nozzle body of the nozzle arrangement from FIG. 1a,

FIG. 1g shows a detailed cross-sectional view of the nozzle body in the region of the exit opening,

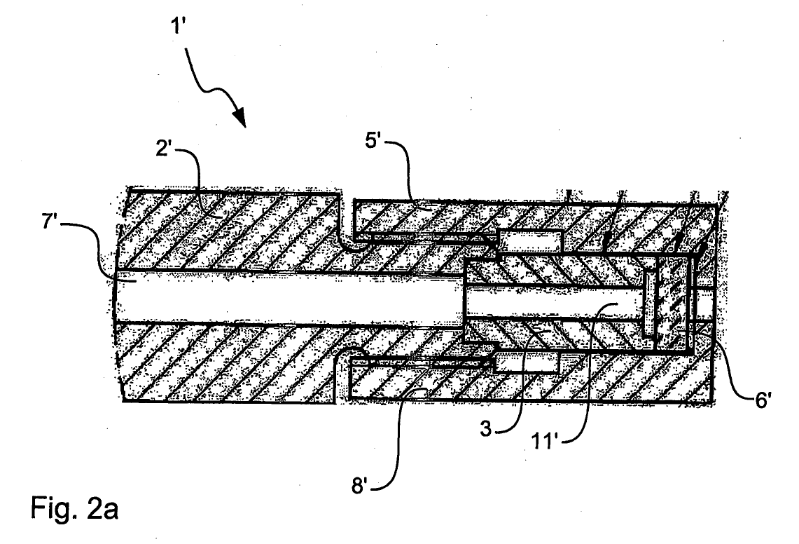

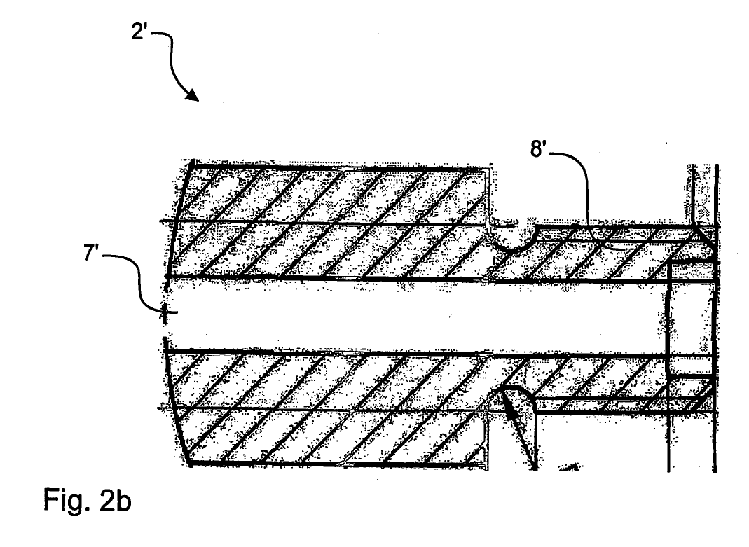

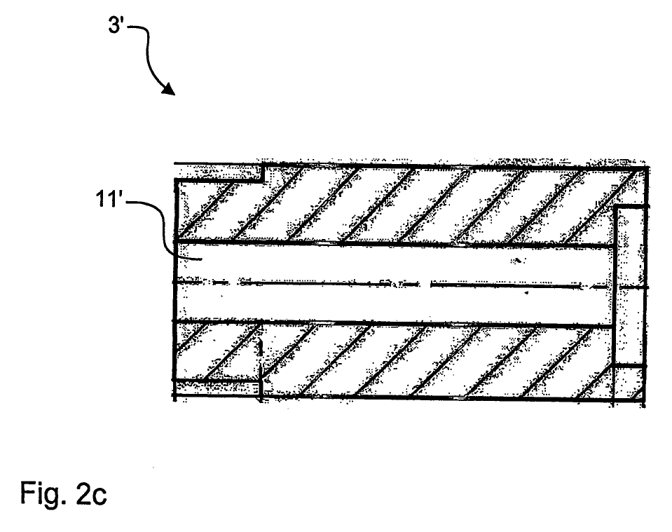

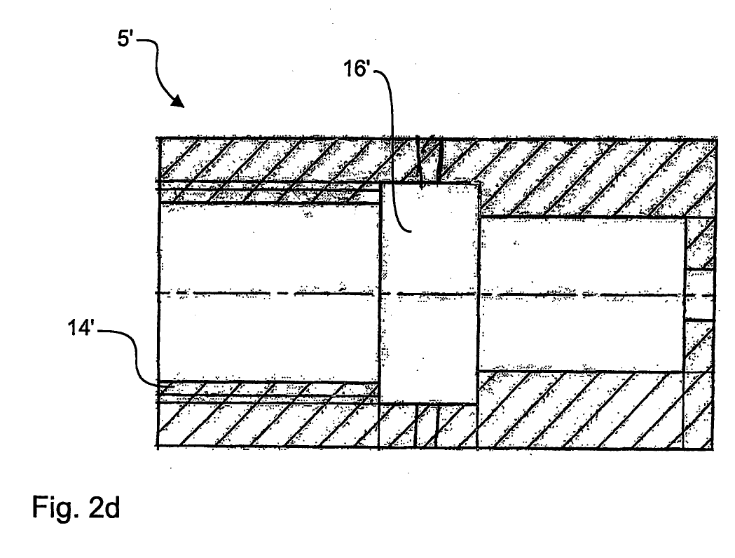

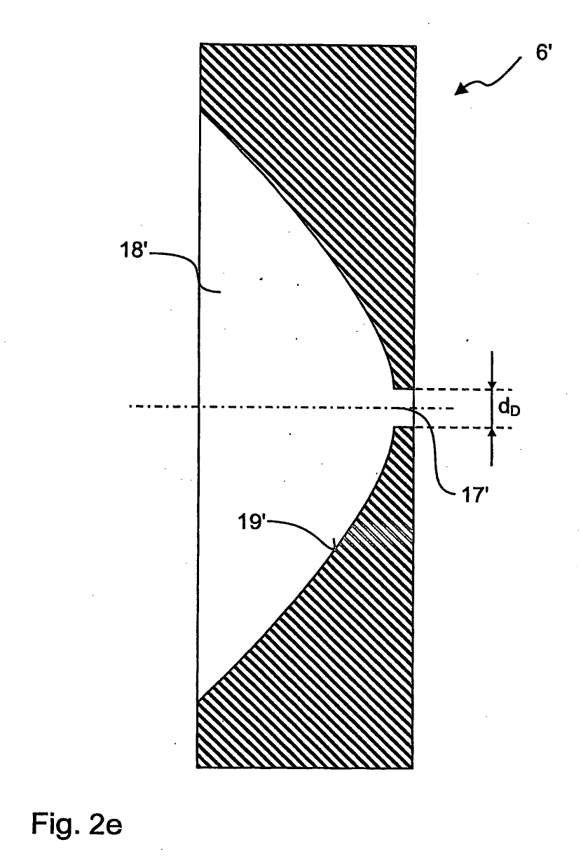

FIG. 2a shows an alternative example of embodiment of a nozzle arrangement according to the invention in a cross-sectional view,

FIG. 2b shows the supply line of the nozzle arrangement from FIG. 2a in a cross-sectional view,

FIG. 2c shows the seal of the nozzle arrangement from FIG. 2a in a cross-sectional view,

FIG. 2d shows the screw cap of the nozzle arrangement from FIG. 2a in a cross-sectional view,

FIG. 2e shows a detailed cross-sectional view of the nozzle body of the nozzle arrangement from FIG. 2a and

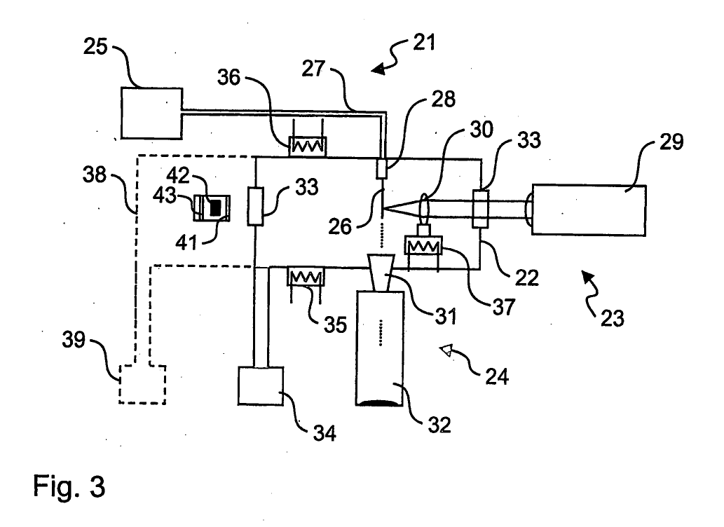

FIG. 3 shows an x-ray source with a nozzle arrangement according to the invention.

Nozzle arrangement 1 according to the invention represented in FIG. 1a essentially comprises a supply line 2, a seal 3, a screw sleeve 4 screwed onto supply line 2, a screw cap 5 screwed onto screw sleeve 4 and a nozzle body 6 inserted into the seal 3, which nozzle body 6 is not represented in FIG. 1a for the sake of simplicity and is shown in detail in FIGS. 1f and 1g.

The pressure-tight nozzle arrangement 1 is suitable, particularly advantageously, for the injection of a fluid jet into a vacuum chamber, since a stable fluid jet can be produced with the nozzle arrangement 1.

The supply line 2 is shown in detail in FIG. 1b and has a through-going internal channel 7 for the supply of the injected fluid.

At its free end, the supply line 2 has a head 8 with an external diameter of 4 mm, whereby the head 8 carries an external thread, which in the assembled state engages in a correspondingly matched internal thread 9 in the screw sleeve 4, whereby the screw sleeve 4 is shown in detail in FIG. 1c.

Furthermore, the head 8 of the supply line 2 has at its free end face a conical widened portion of the internal channel 7, whereby the cone angle of the widened portion amounts to 90°.

The seal 3 shown in detail in FIG. 1d has at its side facing the supply line 2 a corresponding conical tapered portion 10, whereby the cone angle of the tapered portion 10 also amounts to 90°. In the assembled state shown in FIG. 1a, the tapered portion 10 of the seal 3 rests in the conical widened portion of the internal channel 7 of the supply line 2.

The seal 3 is made here of nylon and is thus much softer than the supply line 2 made of metal. On the one hand, this material selection produces a good sealing effect for the seal 3. On the other hand, a relatively wear-susceptible metal-glass transition is thus avoided.

The seal 3 also has a through-going internal channel 11, through which the injected fluid is conveyed onwards.

Inside the seal 3, the internal channel 11 transforms into a receiving chamber 12, in which the nozzle body 6 shown in FIGS. 1f and 1g is disposed in the assembled state, whereby the nozzle body 6 will be described further in detail.

On the side facing away from the supply line 2, the seal 3 also has a conical tapered portion 13, whereby the cone angle of the tapered portion 13 amounts to only 15°.

The screw cap 5, which is shown in detail in FIG. 1e, serves to fix the seal 3 in the screw sleeve 4.

The screw cap 5 thus has at its inner side an internal thread 14, which in the assembled state engages in a corresponding external thread 15, which is provided in the external lateral face of the screw sleeve 4. When screwing up takes place, therefore, the screw cap 5 thus presses the seal 3 axially against the supply line 2, whereby the screw sleeve 4 fixes the screwed connection, comprising the screw cap 5 and the screw sleeve 4, to the supply line 2.

A radially through-going drill-hole 16 is provided in the screw cap 5, said drill-hole 16 serving as a shoulder for a screwing tool in order to be able to screw down the screw cap 5 on the screw sleeve 4.

The nozzle body 6 shown in FIGS. 1f and 1g is described below in greater detail.

The nozzle body 6 thus essentially comprises a hollow-cylindrical glass tube, which is transparent and thus permits the detection of bubbles or contaminations inside the nozzle body 6 by a simple visual inspection.

A further advantage of the use of glass as the material for the nozzle body 6 consists in the good workability, so that an exit opening 17 with an internal diameter of d_{D}=20 μm can be produced.

The use of the seal 3 made of plastics material advantageously prevents a glass-metal transition to the supply line 2, since such a glass-metal transition would be very susceptible to wear.

Furthermore, the nozzle body 6 has a through-going nozzle channel 18, whereby the nozzle channel 18 has a concave internal contour 19 in a region adjacent to the exit opening 17. The concave internal contour 19 of the nozzle channel 18 contributes to a laminar flow at the exit opening 17 and thus promotes the stability of the injected fluid jet.

In addition, the nozzle body 6 has a convex external contour 20 in a region adjacent to the exit opening 17, as a result of which a stable fluid jet is also promoted.

The example of an embodiment of a nozzle arrangement 1′ according to the invention shown in FIGS. 2a to 2e largely agrees with the example of embodiment described previously, so that for the most part reference is made to the preceding description in order to avoid repetitions and the same reference numbers are used below for corresponding components, said reference numbers merely being identified with an apostrophe for the purpose of creating a distinction.

A distinctive feature of the nozzle arrangement 1′ consists in the fact that the nozzle body 6′ does not have a convex external contour, but is designed as a cylindrical glass piece.

The nozzle channel 18′ disposed in the nozzle body 6′, however, also has a concave internal contour 19′ in order to achieve as laminar a flow as possible.

An example of an x-ray source according to the invention is illustrated diagrammatically in FIG. 3.

The x-ray source comprises a target source 21 which is connected to a heat-regulatable vacuum chamber 22, an irradiation device 23 and a collecting device 24.

The target source 21 comprises a reservoir 25 for a target material 26, a supply line 27 and a nozzle arrangement 28, which is designed according to FIGS. 1a-1g or 2a-2e. With an actuation device (not shown), which comprises for example a pump or a piezoelectric conveying device, the target material 26 is conveyed to the nozzle arrangement 28 and delivered from the latter in the form of a fluid jet and injected into the vacuum chamber 22.

The irradiation device 23 comprises a radiation source 29 and irradiation optics 30, with which radiation from the radiation source 29 can be focused on the target material 26. The radiation source 29 is for example a laser, whose light is deflected, optionally with the aid of defection mirrors (not shown), towards the target material 26. Alternatively, an ion source or an electron source, which is also disposed in the vacuum chamber 22, can be provided as the irradiation device 23.

The collecting device 24 comprises a receiver 31, e.g. in the form of a funnel or a capillary vessel, which removes the target material 26, that is not vaporised under the effect of the irradiation, from the vacuum chamber 22 and conveys it into the collecting container 32. When use is made of a fluid target material 26 with a low vapour pressure, the collected fluid can, to advantage, be caught in the collecting container 32 without further measures. In order to avoid, where the need arises, the risk of a backflow of the collected target material 26 into the vacuum chamber 22, cooling of the collecting container 32 can be provided with a cooling device (not shown) and/or a vacuum pump (not shown).

The vacuum chamber 22 comprises a housing with at least a first window 33, through which the target material 26 can be irradiated, and at least a second window 33, through which the generated x-radiation exits. The second window 33 is provided optionally, in order to decouple the generated x-radiation out of the vacuum chamber 22 for a specific use. If this is not necessary, the second window 33 can be dispensed with. The vacuum chamber 22, furthermore, is connected to a vacuum device 34, with which an under-pressure is generated in the vacuum chamber 22. This under-pressure preferably lies below 10⁻⁵ mbar. The irradiation optics 30 are also disposed in the vacuum chamber 22.

The vacuum chamber 22 is equipped with a heating device, which comprises one or more thermostats 35-37. The housing of the vacuum chamber 22, the receiver 32 and/or the irradiation optics 30 can be temperature-regulated with thermostats 35-37. If need be, the target source 21 can also be temperature-regulated. A thermostat comprises for example a resistance heating known per se.

The temperature adjusted with the heating device is selected in such a way that the vapour pressure of the target material 26 exceeds the gas pressure that is created by irradiation of the target material 26 with the irradiation device 23. According to the invention, an over-saturation of the gas phase in the vacuum chamber 22 is thus avoided. The liberated polymer remains gaseous and can be pumped away almost quantitatively with the vacuum device 34.

The second window 33 is made of a window material, e.g. beryllium, transparent for soft x-radiation. If the second window 33 is provided, an evacuatable processing chamber 38 can follow, said processing chamber being connected to a further vacuum device 39. The x-radiation can be imaged onto an object in the processing chamber 38 for the material processing. An x-ray lithography device 40, for example, is provided, with which the surface of a semiconductor substrate is irradiated. The spatial separation of the x-ray source in the vacuum chamber 22 and the x-ray lithography device 40 in the processing chamber 38 has the advantage that the material to be processed is not exposed to deposits of the evaporated target material 26.

The X-ray lithography device 40 comprises, for example, a filter 41 for the selection of the desired x-ray wavelength, a mask 42 and a substrate 43 to be irradiated. In addition, imaging optics (e.g. mirrors) can be provided in order to deflect the x-radiation onto the x-ray lithography device 40.

The invention is not restricted to the preferred examples of embodiment described above. On the contrary, a large number of variants and modifications are possible, which also make use of the idea of the invention and therefore fall within the scope of protection.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. A nozzle arrangement for the injection of a fluid into a vacuum chamber, with a nozzle channel, with a predetermined internal contour, whereby the nozzle channel leads into an exit opening, wherein the internal contour of the nozzle channel is shaped concavely at least in part.

25. The nozzle arrangement according to claim 24, wherein the internal contour of the nozzle channel has a parabolic shape.

26. The nozzle arrangement according to claim 24, wherein the nozzle channel has a parabolic internal contour in a region adjacent to the exit opening.

27. The nozzle arrangement according to claim 24, wherein the nozzle channel has a concave internal contour in a region adjacent to the exit opening.

28. The nozzle arrangement according to claim 24, wherein the exit opening has an internal diameter in the range from 1 μm to 0.5 mm.

29. The nozzle arrangement according to claim 24, wherein the nozzle channel runs in a nozzle body, whereby the nozzle body has at least in part a convex external contour.

30. The nozzle arrangement according to claim 29, wherein the nozzle body has a parabolic external contour.

31. The nozzle arrangement according to claim 29, wherein the nozzle body has a parabolic external contour in a region adjacent to the exit opening.

32. The nozzle arrangement according to claim 29, wherein the nozzle body has a convex external contour in a region adjacent to the exit opening.

33. The nozzle arrangement according to claim 32, wherein the nozzle body is composed of a material selected from quartz, sapphire or glass.

34. The nozzle arrangement according to claim 32, wherein the nozzle body is composed of a transparent material.

35. The nozzle arrangement according to claim 32, wherein the nozzle body is composed of a thermally conductive material.

36. The nozzle arrangement according to claim 32, wherein the nozzle body is connected to a supply line, whereby a seal is disposed between the nozzle body and the supply line.

37. The nozzle arrangement according to claim 36, wherein the seal is composed of a softer material than the nozzle body.

38. The nozzle arrangement according to claim 37, wherein the seal is composed of a plastic material.

39. The nozzle arrangement according to claim 36, wherein the seal is composed of a softer material than the supply line.

40. The nozzle arrangement according to claim 36, wherein the supply line has an internal diameter in the range from 0.1 mm to 5 mm.

41. The nozzle arrangement according to claim 36, wherein the seal has an internal diameter in the range from 0.01 mm to 5 mm.

42. The nozzle arrangement according to claim 36, wherein the internal diameters of the supply line, the seal and the nozzle channel differ by less than the factor 2.

43. The nozzle arrangement according to claim 36, wherein a screwed connection is provided for the connection of the supply line, the seal and the nozzle body.

44. The nozzle arrangement according to claim 43, wherein the screwed connection comprises a screw sleeve which can be screwed up with the supply line and a screw cap which can be screwed up with the screw sleeve.

45. The nozzle arrangement according to claim 44, wherein the screw cap has a shoulder for a tool in order to screw down the screw cap.

46. The nozzle arrangement according to claim 24, wherein the nozzle arrangement has a compressive strength of at least 100 bar.

47. A device with a vacuum chamber and a nozzle arrangement according to claim 24 for the injection of a fluid jet into the vacuum chamber.

48. An operating process for a device according to claim 47 with the following steps:
injection of a fluid jet into the vacuum chamber by means of the nozzle arrangement, and
evacuation of the vacuum chamber during or after the injection of the fluid jet.

49. The operating process for a device according to claim 47, wherein the nozzle arrangement is heated.
